(19) United States
(12) Patent Application Publication
(10) Pub. No.: US 2015/0035205 A1
(43) Pub. Date: Feb. 5, 2015

(54) PROCESS FOR PRODUCING FLEXOGRAPHIC PRINTING PLATE PRECURSOR FOR LASER ENGRAVING, FLEXOGRAPHIC PRINTING PLATE PRECURSOR FOR LASER ENGRAVING, PROCESS FOR MAKING FLEXOGRAPHIC PRINTING PLATE, AND FLEXOGRAPHIC PRINTING PLATE

(71) Applicant: FUJIFILM Corporation, Tokyo (JP)

(72) Inventor: Mamoru KURAMOTO, Haibara-gun (JP)

(73) Assignee: FUJIFILM CORPORATION, Tokyo (JP)

(21) Appl. No.: 14/444,642

(22) Filed: Jul. 28, 2014

(30) Foreign Application Priority Data
Jul. 31, 2013 (JP) 2013-159251

(51) Int. Cl. B29C 59/16

(52) U.S. Cl. CPC B29C 59/16; B29L 2007/001
USPC 264/400

(57) ABSTRACT

Objects of the present invention are to provide a process for producing a flexographic printing plate precursor for laser engraving that has excellent rinsing properties for engraving residue and can give a plate having excellent printing durability, to provide a flexographic printing plate precursor obtained by the process, and to provide a flexographic printing plate and a process for making the flexographic printing plate. Disclosed is a process for producing a flexographic printing plate precursor for laser engraving, comprising steps of: forming a relief-forming layer formed of a resin composition for laser engraving; and crosslinking the relief-forming layer by means of heat and/or light to thus obtain a flexographic printing plate precursor having a crosslinked relief-forming layer, wherein the resin composition for laser engraving comprises (Component A) an N-vinyl compound, (Component B) a polymerizable compound, (Component C) an ethylenically unsaturated bond-containing binder polymer, and (Component D) a polymerization initiator.

### CROSS REFERENCE TO RELATED APPLICATIONS

This application claims priority under U.S.C. 119 from Japanese Patent Application No. 2013-159251 filed on Jul. 31, 2013, the entire contents of which are incorporated by reference herein.

### TECHNICAL FIELD

The present invention relates to a process for producing a flexographic printing plate precursor for laser engraving, a flexographic printing plate precursor for laser engraving, a process for making a flexographic printing plate, and a flexographic printing plate.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a resin composition for laser engraving, those described in JP-A-2009-119810 (JP-A denotes a Japanese unexamined patent application publication), JP-A-2011-68030, JP-A-2012-30587, or JP-A-2009-119801 are known.

### SUMMARY OF INVENTION

Objects of the present invention are to provide a process for producing a flexographic printing plate precursor for laser engraving that has excellent rinsing properties for engraving residue generated at the time of laser engraving and can give a plate having excellent printing durability, to provide a flexographic printing plate precursor obtained by the process, and to provide a flexographic printing plate and a process for making the flexographic printing plate.

The objects of the present invention have been attained by means described in <1>, <17>, <18>, or <20> below. They are given below together with <2> to <16> and <19>, which are preferred embodiments.

<1> A process for producing a flexographic printing plate precursor for laser engraving, comprising steps of: forming a relief-forming layer formed of a resin composition for laser engraving; and crosslinking the relief-forming layer by means of heat and/or light to thus obtain a flexographic printing plate precursor having a crosslinked relief-forming layer, wherein the resin composition for laser engraving comprises (Component A) an N-vinyl compound, (Component B) a polymerizable compound, (Component C) an ethylenically unsaturated bond-containing binder polymer, and (Component D) a polymerization initiator,

<2> the process for producing a flexographic printing plate precursor for laser engraving according to <1>, wherein Component A is N-vinyllactams,

<3> the process for producing a flexographic printing plate precursor for laser engraving according to <1> or <2>, wherein Component A is a compound represented by the following Formula (A-1),

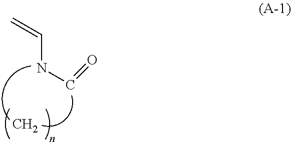

(in Formula (A-1), n represents an integer of 2 to 6),

<4> the process for producing a flexographic printing plate precursor for laser engraving according to any one of <1> to <3>, wherein Component A is N-vinyl-ε-caprolactam,

<5> the process for producing a flexographic printing plate precursor for laser engraving according to any one of <1> to <4>, wherein, in the resin composition, a molar ratio between a total amount of the ethylenically unsaturated group of Component A and a total amount of the ethylenically unsaturated group of Component B (value of Component A/value of Component B) is at least 0.05 but no greater than 3,

<6> the process for producing a flexographic printing plate precursor for laser engraving according to any one of <1> to <5>, wherein Component B is a compound having an isocyanuric acid structure or a cyanuric acid structure,

<7> the process for producing a flexographic printing plate precursor for laser engraving according to any one of <1> to <6>, wherein Component B is a compound having an allyl group,

<8> the process for producing a flexographic printing plate precursor for laser engraving according to any one of <1> to <7>, wherein a content of Component A is less than 20 mass % relative to a total mass of the resin composition,

<9> the process for producing a flexographic printing plate precursor for laser engraving according to any one of <1> to <8>, wherein Component C comprises a resin having a monomer unit derived from butadiene and/or a monomer unit derived from isoprene,

<10> the process for producing a flexographic printing plate precursor for laser engraving according to any one of <1> to <9>, wherein the resin composition for laser engraving further comprises (Component E) a photothermal conversion agent,

<11> the process for producing a flexographic printing plate precursor for laser engraving according to <10>, wherein Component E is carbon black,

<12> the process for producing a flexographic printing plate precursor for laser engraving according to <11>, wherein an average primary particle diameter of the carbon black is greater than 20 nm but less than 80 nm,

<13> the process for producing a flexographic printing plate precursor for laser engraving according to <11> or <12>, wherein a DBP oil absorption number of the carbon black is 40 to 150 mL/100 g,

<14> the process for producing a flexographic printing plate precursor for laser engraving according to any one of <10> to <13>, wherein a content of Component E is 1 to 20 mass % relative to a total mass of the resin composition,

<15> the process for producing a flexographic printing plate precursor for laser engraving according to any one of <1> to <14>, wherein a content of Component C is 50 to 85 mass % relative to a total mass of the resin composition,

<16> the process for producing a flexographic printing plate precursor for laser engraving according to any one of <1> to <15>, wherein the crosslinking step is a step of crosslinking the relief-forming layer by means of heat to thus obtain a flexographic printing plate precursor having a crosslinked relief-forming layer,

<17> a flexographic printing plate precursor for laser engraving obtained by the production process according to any one of <1> to <16>,

<18> a process for making a flexographic printing plate, comprising steps of: an engraving step of laser-engraving the flexographic printing plate precursor for laser engraving obtained by the production process according to any one of <1> to <16> to thus form a relief layer; and a rinsing step of rinsing the surface of the relief layer with a rinsing liquid,

<19> the process for making a flexographic printing plate according to <18>, wherein the rinsing liquid is an alkaline rinsing liquid having a pH of 8 to 14,

<20> a flexographic printing plate obtained by the process for making a flexographic printing plate according to <18> or <19>.

### DESCRIPTION OF EMBODIMENTS

Hereinafter, the content of the present invention will be described in detail. The constituents mentioned below will be described based on typical embodiments of the present invention. However, the present invention is not limited to the embodiments.

In the present specification, “to” is used to describe a range which comprises numerical values listed before and after “to” as a lower limit and an upper limit.

Moreover, in the present invention, “(Component A) N-vinyl compound” or the like is simply described as “Component A” or the like in some cases.

Furthermore, in the present specification, regarding a “group (atomic group)”, if there is no description regarding whether the “group” is substituted or unsubstituted, it means that the “group” includes a group having a substituent and a group not having a substituent. For example, an “alkyl group” includes not only an alkyl group not having a substituent (unsubstituted alkyl group) but also an alkyl group having a substituent (substituted alkyl group).

In the present invention, “part by mass” and “mass %” have the same definition as “part by weight” and “weight %” respectively.

In addition, in the present invention, preferred embodiments in a combination are more preferable.

The process for producing a flexographic printing plate precursor for laser engraving of the present invention includes a layer formation step of forming a relief-forming layer formed of a resin composition for laser engraving (hereinafter, referred to as a “resin composition for laser engraving of the present invention”, or simply referred to as a “resin composition”), and a crosslinking step of crosslinking the relief-forming layer by means of heat and/or light to thus obtain a flexographic printing plate precursor having a crosslinked relief-forming layer, in which the resin composition for laser engraving comprises (Component A) an N-vinyl compound, (Component B) a polymerizable compound, (Component C) an ethylenically unsaturated bond-containing binder polymer, and (Component D) a polymerization initiator. Hereinafter, the resin composition for laser engraving of the present invention will be described first.

### (Resin Composition for Laser Engraving)

The resin composition for laser engraving of the present invention comprises (Component A) an N-vinyl compound, (Component B) a polymerizable compound, (Component C) an ethylenically unsaturated bond-containing binder polymer, and (Component D) a polymerization initiator.

As a result of thorough examination, the present inventor found that if the resin composition for laser engraving comprises Component A to Component D, a resin composition for laser engraving that has excellent rinsing properties for engraving residue generated at the time of laser engraving and can give a flexographic printing plate having excellent printing durability can be provided.

The detailed mechanism thereof is unclear. However, presumably, in the resin composition, a polymerization reaction and a crosslinking reaction with the N-vinyl compound of the polymerizable compound and the ethylenically unsaturated bond-containing binder polymer may be caused by the polymerization initiator, and accordingly, a tough film can be formed, and printing durability of the obtained flexographic printing plate becomes excellent.

In addition, presumably, by the addition of the N-vinyl compound, affinity between the engraving residue and a rinsing liquid may be improved, and/or, viscosity of the engraving residue can be controlled, hence the rinsing properties of the engraving residue generated after laser engraving is improved.

Moreover, presumably, if the resin composition for laser engraving comprises a photothermal conversion agent, a nitrogen atom of the N-vinyl compound may be adsorbed onto the interface of the photothermal conversion agent through a hydrogen bond, or, a polymerization reaction and a crosslinking reaction with the N-vinyl compound of the polymerizable compound and the ethylenically unsaturated bond-containing binder polymer may be caused by the polymerization initiator, and accordingly, a network having the photothermal conversion agent as a core is formed, and thus, the film strength is further improved.

In the present specification, with respect to explanation of the flexographic printing plate precursor, a non-crosslinked crosslinkable layer comprising Component A to Component D and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving of the present invention are explained below.

### (Component A) N-Vinyl Compound

The resin composition for laser engraving of the present invention comprises an N-vinyl compound. As a result, rinsing properties of engraving residue generated at the time of laser engraving become excellent, and printing durability of the obtained flexographic printing plate becomes excellent.

The N-vinyl compound is not particularly limited, and known compounds can be used as it.

As the N-vinyl compound, compounds having a ring structure which comprises a nitrogen atom bonded to a vinyl group as a ring member are preferable. The N-vinyl compound is more preferably N-vinylcarbazoles, 1-vinylimidazoles, or N-vinyllactams, and yet more preferably N-vinyllactams.

The N-vinyl compound is preferably a monofunctional N-vinyl compound. In this embodiment, the polymerization reaction and crosslinking reaction between the polymerizable compound and the ethylenically unsaturated bond-containing binder polymer are caused to a sufficient degree, and as a result, printing durability of the obtained flexographic printing plate is further improved.

Specific examples of the N-vinyl compound include compounds such as N-vinyl-ε-caprolactam, N-vinyl-2-pyrrolidone, N-vinyl-2-valerolactam, N-vinylcarbazole, 1-vinyl-1H-imidazole, N-vinylacetamide, N-vinylformamide, N-methyl-N-vinylacetamide, and N-methyl-N-vinylformamide.

Among these, N-vinyllactams, N-vinylcarbazole, or 1-vinyl-1H-imidazole is preferable.

Preferable examples of N-vinyllactams usable in the present invention include compounds represented by the following Formula (A-1).

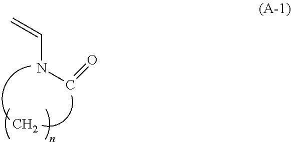

In Formula (A-1), n denotes an integer of 2 to 6. n is preferably an integer of 3 to 5, and more preferably 3 or 5, from the viewpoint of rinsing properties for engraving residue generated when laser engraving, printing durability of flexographic printing plate thus obtained, and ready availability of starting materials.

The N-vinyllactam compound may have a substituent such as an alkyl group or an aryl group on the lactam ring, and may have an unsaturated ring structure bonded to the lactam ring.

Among them, from the viewpoint of printing durability N-vinyl-ε-caprolactam is particularly preferable, and from the viewpoint of rinsing properties N-vinyl-2-pyrrolidone is particularly preferable.

With regard to the N-vinyl compound, one type thereof may be used or two or more types thereof may be used in combination.

The content of the N-vinyl compound is preferably less than 20 mass relative to the entire mass of the resin composition for laser engraving of the present invention, more preferably at least 1 mass % but less than 20 mass %, yet more preferably at least 2 mass % but no greater than 15 mass %, and particularly preferably at least 3 mass % but no greater than 10 mass %. It is preferable for it to be in the above-mentioned range since the rinsing properties for engraving residue generated when laser engraving is excellent, and the printing durability of obtainable flexographic printing plate is excellent.

### (Component B) Polymerizable Compound

In order to promote formation of a crosslinked structure, the resin composition for laser engraving of the present invention comprises (Component B) a polymerizable compound. If the resin composition comprises Component B, formation of a crosslinked structure is promoted, and printing durability of the obtained flexographic printing plate becomes excellent.

Component B is a polymerizable compound other than Component A. Moreover, Component B is preferably a compound having a molecular weight of less than 3,000, and more preferably a compound having a molecular weight of less than 1,000.

Component B is preferably a radically polymerizable compound. In addition, Component B is preferably an ethylenically unsaturated compound.

The resin composition for laser engraving of the present invention preferably comprises as Component B a polyfunctional ethylenically unsaturated compound. When in this mode, an obtainable flexographic printing plate has more excellent printing durability.

The polyfunctional ethylenically unsaturated compound is preferably a compound having 2 to 20 terminal ethylenically unsaturated groups. A group of such compounds is widely known in the present industrial field, and in the present invention these compounds may be used without particular limitations.

Examples of a compound from which the ethylenically unsaturated group in the polyfunctional ethylenically unsaturated compound is derived include an unsaturated carboxylic acid (e.g. acrylic acid, methacrylic acid, itaconic acid, crotonic acid, isocrotonic acid, maleic acid, etc.), and an ester or amide thereof. An ester between an unsaturated carboxylic acid and an aliphatic polyhydric alcohol compound and an amide between an unsaturated carboxylic acid and an aliphatic polyvalent amine compound are preferably used. Furthermore, an addition reaction product of an unsaturated carboxylic acid ester or amide having a nucleophilic substituent such as a hydroxy group or an amino group, and a polyfunctional isocyanate or an epoxide, and a dehydration-condensation reaction product with a polyfunctional carboxylic acid, are also suitably used. Furthermore, an addition reaction product between a monofunctional or polyfunctional alcohol or amine and an unsaturated carboxylic acid ester or amide having an electrophilic substituent such as an isocyanate group or an epoxy group, and a substitution reaction product between a monofunctional or polyfunctional alcohol or amine and an unsaturated carboxylic acid ester or amide having a leaving substituent such as a halogen group or a tosyloxy group are also suitable. As another example, a group of compounds formed by replacing the unsaturated carboxylic acid with a vinyl compound, an allyl compound, an unsaturated phosphonic acid, or styrene may also be used.

The ethylenically unsaturated group contained in Component B is preferably an acrylate, methacrylate, vinyl compound, or allyl compound residue from the viewpoint of reactivity. Furthermore, from the viewpoint of printing durability, the polyfunctional ethylenically unsaturated compound preferably comprises at least three ethylenically unsaturated groups.

It is preferable for Component B to comprise an allyl group-containing compound, that is, an allyl compound. In this embodiment, copolymerization properties of Component B and the N-vinyl compound become excellent, rinsing properties for engraving residue generated at the time of laser engraving are further improved, and printing durability of the obtained flexographic printing plate is further improved.

Examples of the allyl compounds include polyethylene glycol diallyl ether, 1,4-cyclohexane diallyl ether, 1,4-diethylcyclohexyl diallyl ether, 1,8-octane diallyl ether, trimethylolpropane diallyl ether, trimethylolethane triallyl ether, pentaerythritol triallyl ether, pentaerythritol tetraallyl ether, dipentaerythritol pentaallyl ether, dipentaerythritol hexaallyl ether, diallyl phthalate, diallyl terephthalate, diallyl isophthalate, triallyl isocyanurate, triallyl cyanurate, triallyl phosphate, etc.

Among them, as the allyl compounds, triallyl isocyanurate and triallyl cyanurate are particularly preferable, and triallyl isocyanurate is most preferable.

Specific examples of ester monomers comprising an ester of a polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, aliphatic alcohol-based esters described in JP-B-46-27926, JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture of two or more types.

Furthermore, specific examples of amide monomers of an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based addition-polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (i) below is added to a polyisocyanate compound having two or more isocyanate groups per molecule described in JP-B-48-41708.

CH₂═C(R)COOCH₂CH(R)OH (i)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure in the molecule described in JP-A-63-277653, JP-A-63-260909, and JP-A-1-105238, the resin composition having excellent curability can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Examples of the vinyl compounds include butanediol-1,4-divinyl ether, ethylene glycol divinyl ether, 1,2-propanediol divinyl ether, 1,3-propanediol divinyl ether, 1,3-butanediol divinyl ether, 1,4-butanediol divinyl ether, neopentyl glycol divinyl ether, trimethylolpropane tirvinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylenevinyl ether, ethylene glycol dipropylenevinyl ether, trimethylolpropane triethylenevinyl ether, trimethylolpropane diethylenevinyl ether, pentaerythritol diethylenevinyl ether, pentaerythritol triethylenevinyl ether, pentaerythritol tetraethylenevinyl ether, 1,1,1-tris[4-(2-vinyloxyethoxy)phenyl]ethane, bisphenol A divinyloxyethyl ether, divinyl adipate, etc.

Component B is preferably a compound having an isocyanuric acid structure or a cyanuric acid structure. In this embodiment, the compound and the N-vinyl compound may interact with each other and become close to each other, and accordingly, a stronger crosslinked film is obtained. Moreover, by the addition of the compound, hydrophilicity of the engraving residue becomes appropriate, rinsing properties of the engraving residue generated at the time of laser engraving are further improved, and printing durability of the obtained flexographic printing plate is further improved.

The isocyanuric acid structure is a structure represented by the following Formula (B-1) and is referred to as an “isocyanuric acid structure” or an “isocyanurate group”, and the cyanuric acid structure is a structure represented by the following Formula (B-2) and is referred to as a “cyanuric acid structure” or a “cyanurate group”.

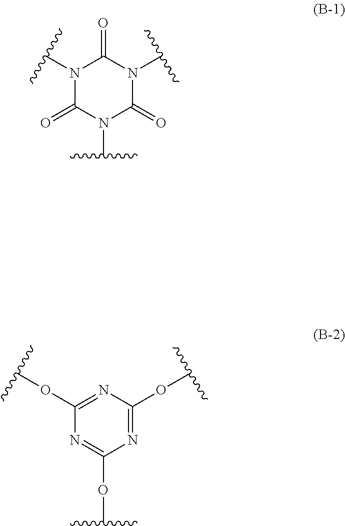 [SMILES: *n1c(=O)n(*)c(=O)n(*)c1=O ; *Oc1nc(O*)nc(O*)n1]

(In each of the formulae, each of the wavy line portions independently denotes a portion to be bonded to other portions.)

Preferable examples of the compound having an isocyanuric acid structure or a cyanuric acid structure include alkylene oxide-modified isocyanuric acid tri(meth)acrylate, and ε-caprolactam-modified tris((meth)acryloxyalkyl)isocyanurate, in addition to the aforementioned triallyl isocyanurate and triallyl cyanurate.

The resin composition for laser engraving of the present invention may comprise a monofunctional ethylenically unsaturated compound, but if the resin composition comprises a monofunctional ethylenically unsaturated compound, it is preferable that the resin composition comprise a monofunctional ethylenically unsaturated compound in combination with a polyfunctional ethylenically unsaturated compound.

Examples of the monofunctional ethylenically unsaturated compound having one ethylenically unsaturated bond in the molecule include esters of unsaturated carboxylic acids (for example, acrylic acid, methacrylic acid, itaconic acid, crotonic acid, isocrotonic acid, and maleic acid) and monohydric alcohol compounds, and amides of unsaturated carboxylic acids and monovalent amine compounds.

Furthermore, addition reaction products of an unsaturated carboxylic acid ester or amide having a nucleophilic substituent such as a hydroxyl group, an amino group or a mercapto group, and an isocyanate or an epoxide, and dehydration condensation reaction products with a monofunctional or polyfunctional carboxylic acid, are also suitably used.

Furthermore, addition reaction products of an unsaturated carboxylic acid ester or amide having an electrophilic substituent such as an isocyanato group or an epoxy group, and an alcohol, an amine or a thiol, and substitution reaction products of an unsaturated carboxylic acid ester or amide having a detachable substituent such as a halogeno group or a tosyloxy group, and an alcohol, an amine or a thiol, are also suitable.

Also, as other examples, a group of compounds substituted with unsaturated phosphonic acid, styrene, vinyl ether or the like instead of the unsaturated carboxylic acid described above, can also be used.

The polymerizable compound is not particularly limited, and various known compounds can be used in addition to the compounds exemplified above. For example, those compounds described in JP-A-2009-204962 and the like may also be used.

Component B is preferably a compound having a melting point of equal to or higher than 0° C. In this embodiment, the film strength is improved, and printing durability is further improved.

With regard to Component B in the resin composition for laser engraving of the present invention, only one type may be used on its own or two or more types may be used in combination.

The content of Component B in the resin composition for laser engraving of the present invention is preferably 0.1 to 30 mass %, more preferably 0.5 to 20 mass %, yet more preferably 1 to 10 mass %, and particularly preferably 3 to 8 mass %, relative to the total mass of the resin composition. It is preferable for it to be in the above-mentioned range since rinsing properties for engraving residue generated when laser engraving is more excellent, and printing durability of flexographic printing plate thus obtained is more excellent.

In addition, in the resin composition for laser engraving of the present invention, a molar ratio between a total amount of the ethylenically unsaturated group of Component A and a total amount of the ethylenically unsaturated group of Component B (value of Component A/value of Component B) is preferably at least 0.05 but no greater than 3, more preferably at least 0.1 but no greater than 2, and yet more preferably at least 0.2 but no greater than 1. If the molar ratio is within the above range, the crosslinked structure can be formed in an appropriate amount, and printing durability of the obtained flexographic printing plate is further improved. (Component C) Ethylenically unsaturated group-containing binder polymer

The resin composition for laser engraving of the present invention comprises (Component C) an ethylenically unsaturated group-containing binder polymer. If the resin composition comprises Component C, formation of the crosslinked structure is promoted, and printing durability of the obtained flexographic printing plate becomes excellent.

The ethylenically unsaturated group in Component C is not particularly limited, but is preferably a (meth)acryloyloxy group or an ethylenically unsaturated group derived from a conjugated diene in a conjugated diene polymer, and more preferably an ethylenically unsaturated group derived from a conjugated diene. When in this mode, a uniform crosslinked film is obtained and a film that is tough and exhibits good rubber elasticity is obtained.

Component C is not particularly limited as long as it is an ethylenically unsaturated group-containing polymer compound, but is preferably a polymer selected from the group consisting of a conjugated diene-based polymer, a terminal ethylenically unsaturated group-containing conjugated diene-based polymer, and an ethylenically unsaturated group-containing polyurethane resin; it is more preferably a polymer selected from the group consisting of a conjugated diene-based polymer, a terminal (meth)acryloyloxy group-containing conjugated diene-based polymer and a (meth)acryloyloxy group-containing polyurethane resin, and it is yet more preferably a conjugated diene-based polymer.

In addition, it is preferable for Component C to comprise a resin having a monomer unit derived from butadiene and/or a monomer unit derived from isoprene. From the viewpoint of rinsing properties, the resin is more preferably polybutadiene or polyisoprene.

The monomer unit derived from butadiene may be a monomer unit obtained by 1,4-addition of butadiene or a monomer unit obtained by 1,2-addition of butadiene.

Moreover, the monomer unit derived from isoprene may be a monomer unit obtained by 1,4-addition of isoprene, a monomer unit obtained by 1,2-addition of isoprene, or a monomer unit obtained by 3,4-addition of isoprene.

Examples of the conjugated diene-based polymer include a polymer obtained by polymerization of a conjugated diene-based hydrocarbon and a copolymer obtained by polymerization of a conjugated diene-based hydrocarbon and a monoolefin-based unsaturated compound.

Specific examples of the conjugated diene-based hydrocarbon include 1,3-butadiene, isoprene, and chloroprene. With regard to these compounds, they may be used on their own or in a combination of two or more types.

Specific examples of the monoolefin-based unsaturated compound include styrene, a-methylstyrene, o-methylstyrene, p-methylstyrene, acrylonitrile, methacrylonitrile, vinyl chloride, vinylidene chloride, acrylamide, methacrylamide, vinyl acetate, an acrylic acid ester, a methacrylic acid ester, acrylic acid, and methacrylic acid.

Specific examples of polymers obtained by polymerization of the conjugated diene-based hydrocarbon and copolymers obtained by copolymerization of the conjugated diene-based hydrocarbon and the monoolefin-based unsaturated compound include, but are not particularly limited to, polybutadiene, polyisoprene, polychloroprene, a styrene-butadiene copolymer, a styrene-isoprene polymer, a styrene-chloroprene copolymer, an acrylonitrile-butadiene copolymer, an acrylonitrile-isoprene copolymer, an acrylonitrile-chloroprene copolymer, an acrylic acid ester-isoprene copolymer, an acrylic acid ester-chloroprene copolymer, a copolymer between a methacrylic acid ester and the conjugated diene, an acrylonitrile-butadiene-styrene copolymer, a styrene-isoprene-styrene block polymer, and a styrene-butadiene-styrene block polymer. These polymers may be formed by emulsion polymerization or solution polymerization.

Furthermore, examples of a terminal (meth)acryloyloxy group-containing conjugated diene-based polymer include a polyisoprene into which a methacryloyloxy has been introduced (Kuraprene UC-203, UC-102, Kuraray Co., Ltd.).

Moreover, a terminal ethylenically unsaturated group-containing conjugated diene-based polymer and a terminal ethylenically unsaturated group-containing hydrogenated conjugated diene-based monomer are also preferably used. Examples of the terminal ethylenically unsaturated group-containing conjugated diene-based polymer include a polybutadiene into which a (meth)acryloyloxy group has been introduced (NISSO-PB TEAI-1000, EMA-3000, Nippon Soda Co., Ltd.).

Among them, the conjugated diene-based polymer is yet more preferably polyisoprene, polybutadiene, a styrene-isoprene-styrene block polymer, a styrene-butadiene-styrene block polymer, and particularly preferably polyisoprene or polybutadiene.

Examples of the ethylenically unsaturated group-containing polyurethane resin include, but are not particularly limited to, a urethane (meth)acrylate.

The urethane (meth)acrylate may be derived from, for example, a polyurethane resin having a hydroxy group at a molecular terminal or in a molecular main chain.

The polyurethane resin having a hydroxy group at a molecular terminal as a starting material may be formed by reacting at least one type of polyisocyanate and at least one type of polyhydric alcohol component.

The polyurethane resin having a hydroxy group at a terminal preferably has at least one type of bond selected from a carbonate bond and an ester bond in the molecule. When the polyurethane resin has the above bond, the durability of a printing plate toward an ink cleaning agent comprising an ester-based solvent or an ink cleaning agent comprising a hydrocarbon-based solvent used in printing tends to improve, which is preferable.

A method for producing the polyurethane resin having a hydroxy group at a terminal is not particularly limited, and examples thereof include a method in which a compound that has a carbonate bond or an ester bond, has a plurality of reactive groups such as a hydroxy group, an amino group, an epoxy group, a carboxy group, an acid anhydride group, a ketone group, a hydrazine residue, an isocyanate group, an isothiocyanate group, a cyclic carbonate group, or an alkoxycarbonyl group, and has a molecular weight of on the order of a few thousand is reacted with a compound having a plurality of functional groups that can be bonded to the above-mentioned reactive groups (e.g. a polyisocyanate having a hydroxy group, an amino group, etc.) to thus adjust the molecular weight and convert the molecular terminal into a bonding group.

Examples of the diol compound having a carbonate bond that is used in the production of the polyurethane resin having a hydroxy group at a terminal include aliphatic polycarbonate diols such as 4,6-polyalkylene carbonate diol, 8,9-polyalkylene carbonate diol, and 5,6-polyalkylene carbonate diol. Furthermore, aliphatic polycarbonate diols having an aromatic type molecular structure in the molecule may also be used. When a terminal hydroxyl group of these compounds is condensation reacted with a diisocyanate compound such as tolylene diisocyanate, diphenylmethane diisocyanate, hexamethylene diisocyanate, isophorone diisocyanate, dicyclohexylmethane diisocyanate, tetramethylxylene diisocyanate, xylene diisocyanate, naphthalene diisocyanate, tri methylhexamethylene diisocyanate, p-phenylene diisocyanate, cyclohexylene diisocyanate, lysine diisocyanate, or triphenylmethane diisocyanate; or a triisocyanate compound such as triphenylmethane triisocyanate, 1-methylbenzene-2,4,6-triisocyanate, naphthalene-1,3,7-triisocyanate, or biphenyl-2,4,4′-triisocyanate, a urethane bond can be introduced.

Examples of commercially available urethane (meth)acrylates, etc. include UV-3200, UV-3000B, UV-3700B, UV-3210EA, and UV-2000B of the Shikoh (registered trademark) series (all manufactured by The Nippon Synthetic Chemical Industry Co., Ltd.), EBECRYL 230 and EBECRYL 9227EA (both manufactured by Daicel-Cytec Company Ltd.), and AU-3040, AU-3050, AU-3090, AU-3110, and AU-3120 of the Hi-Coap AU (registered trademark) series (all manufactured by Tokushiki Co., Ltd.).

As another method for obtaining a urethane (meth)acrylate, etc., there is a method in which a polyurethane is formed by a polyaddition reaction between the polyisocyanate compound and a diol compound having a (meth)acryloyloxy group.

Preferred examples of the diol compound having a (meth)acryloyloxy group used in this case include Blemmer GLM manufactured by NOF Corporation and DA-212, DA-250, DA-721, DA-722, DA-91 1 M, DA-920, DA-931, DM-201, DM-81 1, DM-832, and DM-851 of the ‘Denacol Acrylate (registered trademark)’ series manufactured by Nagase ChemteX Corporation.

The molecular weight of Component C is preferably at least 1,000, more preferably at least 3,000, yet more preferably at least 10,000, particularly preferably at least 50,000, and most preferably at least 80,000, in terms of a weight average molecular weight (GPC, expressed in terms of polystyrene). Moreover, the molecular weight of Component C is preferably no greater than 3,000,000, more preferably no greater than 2,000,000, and yet more preferably no greater than 1,500,000, in terms of a weight average molecular weight (GPC, expressed in terms of polystyrene). If the molecular weight is within the above range, the resin composition for laser engraving comprising Component C is easily processed, and printing durability of the obtained flexographic printing plate is further improved.

In the present invention, it is preferable to measure the weight average molecular weight or number average molecular weight by gel permeation chromatography (GPC). In the present invention, for the measurement performed by gel permeation chromatography, it is preferable to use HLC-8020GPC (manufactured by TOSOH CORPORATION), TSKgel Super HZ M-H, TSKgel Super HZ4000, and TSKgel Super HZ200 (manufactured by TOSOH CORPORATION, 4.6 mm ID×15 cm) as columns, and tetrahydrofuran (THF) as an eluent.

In the present invention, with regard to Component C, one type thereof may be used on its own or two or more types may be used in combination.

In the resin composition for laser engraving of the present invention, the content of Component C is preferably 10 to 95 mass % relative to the total mass or the resin composition, more preferably 30 to 90 mass %, yet more preferably 50 to 85 mass %, and particularly preferably 60 to 85 mass %. When the content of Component C is in the above-mentioned range, a film that is highly resistant to ink, tough, and highly flexible can be obtained.

### (Component D) Polymerization Initiator

In order to promote formation of a crosslinked structure, the resin composition for laser engraving of the present invention comprises (Component D) a polymerization initiator.

The polymerization initiator may be either a radical polymerization initiator or a cationic polymerization initiator, but is preferably a radical polymerization initiator.

Moreover, the polymerization initiator may be either a thermopolymerization initiator or a photopolymerization initiator, but is preferably a thermopolymerization initiator.

With regard to the polymerization initiator, one known to a person skilled in the art may be used without any limitations. A radical polymerization initiator, which is a preferred polymerization initiator, is explained in detail below, but the present invention should not be construed as being limited by these descriptions.

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (a) aromatic ketones, (c) organic peroxides and (l) azo compounds are preferable, (c) organic peroxides and (l) azo compounds are more preferably, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bond may preferably include compounds described in paragraphs 0074 to 0118 of JP-A-2008-63554.

Moreover, (c) organic peroxides and (I) azo compounds preferably include the following compounds.

### (c) Organic Peroxides

Preferred examples of the organic peroxide (c) as a radical polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butylperoxyisophthalate, t-butylperoxybenzoate, t-butylperoxy-3-methylbenzoate, t-butylperoxylaurate, t-butylperoxypivalate, t-butylperoxy-2-ethylhexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, t-butylperoxy-2-ethylhexylmonocarbonate, and dicumyl peroxide.

### (I) Azo Compounds

Preferable (I) azo compounds as a radical polymerization initiator that can be used in the present invention include those such as 2,2′-azobisisobutyronitrile, 2,2′-azobispropionitrile, 1,1′-azobis(cyclohexane-1 -carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-tri methylpentane).

It has been found that in the present invention the organic peroxide (c) above is preferable as a polymerization initiator in the present invention from the viewpoint of the crosslinkablility of the film (relief-forming layer), and as an unexpected effect it is particularly preferable from the viewpoint of improvement of engraving sensitivity.

From the viewpoint of engraving sensitivity, combined use of an organic peroxide and a photothermal conversion agent, which is described later, in combination is particularly preferable.

This is presumed as follows. When the relief-forming layer is cured by thermal crosslinking using an organic peroxide, an organic peroxide that did not play a part in radical generation and has not reacted remains, and the remaining organic peroxide works as an autoreactive additive and decomposes exothermally in laser engraving. As the result, energy of generated heat is added to the irradiated laser energy to thus raise the engraving sensitivity.

It will be described in detail in the explanation of photothermal converting agent, the effect thereof is remarkable when carbon black is used as the photothermal converting agent. It is considered that the heat generated from the carbon black is also transmitted to (c) an organic peroxide and, as the result, heat is generated not only from the carbon black but also from the organic peroxide, and that the generation of heat energy to be used for the decomposition of Component C etc. occurs synergistically.

With regard to Component D in the resin composition of the present invention, only one type thereof may be used or two or more types thereof may be used in combination.

The content of Component D in the resin composition for laser engraving of the present invention is preferably 0.1 to 30 mass %, more preferably 0.5 to 20 mass %, and particularly preferably 1 to 15 mass %, relative to the total mass of the resin composition. If the content of Component D is within the above range, rinsing properties of engraving residue generated at the time of laser engraving are further improved, and printing durability of the obtained flexographic printing plate is further improved.

The resin composition for laser engraving of the present invention comprises Component A to Component D as essential components and may comprise another component. Examples of the other component include, but are not limited to, (Component E) a photothermal conversion agent, (Component F) a solvent, (Component G) a filler, and (Component H) a binder polymer other than Component C.

### (Component E) Photothermal Conversion

The resin composition for laser engraving of the present invention preferably comprises (Component E) a photothermal conversion agent.

That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for engraving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the relief printing plate precursor for laser engraving which is produced by using the resin composition for laser engraving of the present invention to comprise a photothermal conversion agent that has a maximun absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific preferable examples include dyes having a maximum absorption wavelength from 700 nm to 1,300 nm, and such preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP (dibutyl phthalate) absorption and also finely divided carbon black having a large specific surface area. Preferred examples of carbon black include Printex (registered trademark) U, Printex (registered trademark) A, Spezialschwarz (registered trademark) 4 (Degussa), and #45L (Mitsubishi Chemical Corporation).

The carbon black that can be used in the present invention has preferably a dibutyl phthalate (DBP) absorption number of no greater than 150 mL/100 g, more preferably no greater than 100 mL/100 g, and yet more preferably no greater than 70 mL/100 g, and preferably at least 40 mL/100 g.

From the viewpoint of improving engraving sensitivity by efficiently transmitting heat generated by photothermal conversion to the surrounding polymer, etc., the carbon black is preferably a conductive carbon black having a BET specific surface area of at least 100 m²/g.

The average primary particle diameter of carbon black usable in the present invention is preferably 10 to 200 nm, and more preferably greater than 20 nm but less than 80 nm. The method for measuring the average primary particle diameter is not particularly limited, and known measurement method can be used for measurement.

Component E in the resin composition for laser engraving of the present invention may be used singly or in a combination of two or more compounds.

The content of the photothermal conversion agent capable in the resin composition for laser engraving of the present invention largely depends on the size of the molecular extinction coefficient characteristic to the molecule, and is preferably 1 to 20 mass % relative to the total mass of the resin composition, more preferably 2 to 10 mass %, and yet more preferably 3 to 5 mass %. When in the above-mentioned range, printing durability of the obtained flexographic printing plate is excellent.

### (Component F) Solvent

The resin composition for laser engraving of the present invention may comprise (Component F) a solvent.

From the viewpoint of dissolving each of the components, a solvent is preferably mainly an aprotic organic solvent. More specifically, solvents are used preferably at aprotic organic solvent/protic organic solvent =100/0 to 50/50 (ratio by mass), more preferably 100/0 to 70/30, and particularly preferably 100/0 to 90/10.

Specific preferred examples of the aprotic organic solvent include hexane, heptane, octane, nonane, cyclohexane, cyclohexannone, acetonitrile, tetrahydrofuran, dioxane, toluene, propylene glycol monomethyl ether acetate (PGMEA), methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among them, propylene glycol monomethyl ether acetate is preferable.

The content of the solvents is not particularly limited, and solvents necessary for forming a relief-forming layer. may be added. Meanwhile, the solid mass content of the resin composition means the content except for the solvents in the resin composition.

The content of each of the components such as Component A to Component E is described based on a total mass of the resin composition. However, when the resin composition comprises a solvent, the content of each of the components is based on a total solid mass content of the resin composition. The solid mass content of the resin composition refers to the amount of the resin composition excluding a volatile component such as a solvent.

### (Component G) Filler

The resin composition for laser engraving of the present invention may comprise (Component G) a filler in order to improve the physical properties of a cured film of the resin composition for laser engraving.

As the filler, a known filler may be used, and examples thereof include inorganic particles and organic resin particles.

As the inorganic particles, known particles may be used, and examples thereof include carbon nanotubes, fullerene, graphite, silica, alumina, aluminum, and calcium carbonate.

As the organic resin particles, known particles may be used, and preferred examples thereof include thermally expandable microcapsules.

As the thermally expandable microcapsules, EXPANCEL (Akzo Noble) can be cited.

The resin composition for laser engraving of the present invention may employ only one type of Component G or two or more types in combination.

The content of the filler (Component G) in the resin composition for laser engraving of the present invention is preferably 0.01 to 20 mass relative to the total mass of the resin composition, more preferably 0.05 to 10 mass %, and particularly preferably 0.1 to 5 mass %.

### (Component H) Binder Polymer Other Than Component C

The resin composition for laser engraving of the present invention may comprise (Component H) a binder polymer other than Component C (hereinafter, also called simply a ‘binder polymer’) that is a resin component other than Component C, but the content thereof is preferably less than the content of Component C, more preferably no greater than 50 mass % of the content of Component C, yet more preferably no greater than 10 mass %, and particularly preferably none, that is, the binder polymer other than Component C (Component H) being not contained.

The binder polymer is a polymer component contained in the resin composition for laser engraving; a usual polymer compound is appropriately selected, and one type may be used on its own or two or more types may be used in combination. In particular, when the resin composition for laser engraving is used in a printing plate precursor, it is preferably selected while taking into consideration various aspects of performance such as laser engraving properties, ink acceptance/transfer, and engraving residue dispersibility.

Examples of the binder polymer include binder polymers described in paragraphs 0009 to 0030 of JP-A-2012-045801.

The weight-average molecular weight of Component H is preferably at least 1,000, more preferably at least 3,000, and yet more preferably at least 10,000.

The resin composition for laser engraving of the present invention may employ only one type of Component H or two or more types in combination.

### <Other Additives>

To the resin composition for laser engraving of the present invention, additives other than Component A to Component H may be added suitably in a range that does not hinder the effect of the present invention. Examples thereof include fragrance, thickener, surfactant, wax, a process oil, a metal oxide, an ozone decomposition inhibitor, an antioxidant, a thermal polymerization inhibitor, a colorant, an alcohol exchange reaction catalyst, etc. With regard to these additives, only one type may be used or two or more types may be used in combination.

The resin composition for laser engraving of the present invention may comprise, as an additive for improving engraving sensitivity, nitrocellulose or a high thermal conductivity material.

Since nitrocellulose is a self-reactive compound, it generates heat during laser engraving, thus assisting thermal decomposition of a coexisting binder polymer. It is surmised that as a result, the engraving sensitivity improves.

A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light and/or heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking can be performed by heat and/or light, and the crosslinking by heat is preferable. Moreover, the crosslinking is not particularly limited only if it is a reaction that cures the resin composition, and is a general idea that includes the crosslinked structure by the reaction of Component A to Component C, etc.

The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The flexographic printing plate precursor for laser engraving may further comprise, as necessary, an adhesive layer between the support and the (crosslinked) relief-forming layer and, above the (crosslinked) relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

The process for producing a flexographic printing plate precursor for laser engraving is not particularly limited, and examples thereof include a method in which a resin composition for laser engraving is prepared, solvent is removed from this resin composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer.

Subsequently, as necessary, a protection film may be laminated on the (crosslinked) relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing a flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, is cast onto a support, and this is dried in an oven to thus remove solvent.

The resin composition for laser engraving can be produced by, for example, a method of mixing Component A to Component C together and sequentially mixing Component D and optionally Component E with the mixture, or a method of dissolving or dispersing Component A to Component C, an optional component, and the like in an appropriate solvent and then mixing Component D and optionally Component E with the solution or dispersion. Since it is preferably to remove most of the solvent component in a stage of producing a flexographic printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the (crosslinked) relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is a production process comprising a crosslinking step of crosslinking the relief-forming layer by means of light and/or heat to thus obtain a flexographic printing plate precursor having a crosslinked relief-forming layer.

The crossliking step is preferably a step of crosslinking the relief-forming layer by means of heat.

The relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

Due to the relief-forming layer being crosslinked, firstly, a relief formed after laser engraving becomes sharp and, secondly, tackiness of engraving residue formed during laser engraving is suppressed.

In the present invention, in the crosslinking step, polymerization reactions of Component A to Component C carry out.

In addition, by using a photopolymerization initiator or the like, the polymerizable compound may be polymerized to form crosslinking, and the crosslinking may be further carried out by means of light (crosslinking step by means of light).

When the relief-forming layer comprises a photopolymerization initiator, the relief-forming layer may be crosslinked by irradiating the relief-forming layer with actinic radiation that triggers the photopolymerization initiator.

It is standard to apply light to the entire surface of the relief-forming layer. Examples of the light (also called ‘actinic radiation’) include visible light, UV light, and an electron beam, but UV light is most generally used. When the side where there is a substrate, such as a relief-forming layer support, for fixing the relief-forming layer, is defined as the reverse face, only the front face need to be irradiated with light, but when the support is a transparent film through which actinic radiation passes, it is preferable to further irradiate from the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

### (Flexographic Printing Plate and Process for Making Same)

The process for making a flexographic printing plate of the present invention preferably comprises a layer formation step of forming a relief-forming layer from the resin composition for laser engraving of the present invention, a crosslinking step of crosslinking the relief-forming layer by means of light and/or heat to thus form a flexographic printing plate precursor having a crosslinked relief-forming layer, and an engraving step of laser-engraving the flexographic printing plate precursor having the crosslinked relief-forming layer. Furthermore, the process preferably comprises a rinsing step of rinsing the surface of the relief layer with a rinsing liquid.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The flexographic printing plate of the present invention may suitably be printable by a UV ink and a solvent ink.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO2 laser) or a semiconductor laser is preferable. In particular, a fiber-coupled semiconductor infrared laser (FC-LD) is preferably used. In general, compared with a CO2 laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2nd Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

### <Rinsing Step, Drying Step, and Post-Crosslinking Step>

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may preferably be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-layer may be added. By carrying out a post-crosslinking step, which is an additional crosslinking step, it is possible to further strengthen the relief formed by engraving.

It is preferable for the rinsing liquid usable in the present invention to be a rinsing liquid with pH 8 to 14. In this embodiment, rinsing properties of engraving residue generated at the time of laser engraving are further improved.

The pH of the rinsing liquid that can be used in the present invention is more preferably at least 9, yet more preferably at least 10, and particularly preferably at least 11. The pH of the rinsing liquid is more preferably no greater than 13.5, and yet more preferably no greater than 13.2. When in the above-mentioned range, handling is easy, and rinsing properties for engraving residue when laser engraving are more excellent.

In order to set the pH of the rinsing liquid in the above-mentioned range, the pH may be adjusted using an acid and/or a base as appropriate, and the acid or base used is not particularly limited. From the viewpoint of cost, etc., preferred examples of the base include a hydroxide of an alkali metal or an alkaline earth metal.

The rinsing liquid that can be used in the present invention is preferably aqueous rinsing liquid comprising water as a main component.

The rinsing liquid may comprise as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

The flexographic printing plate of the present invention is available when it is carried out by a letterpress printer using any of aqueous and oil-based inks, and printing is also possible when it is carried out by a flexographic printer using a UV ink. The flexographic printing plate of the present invention has excellent rinsing properties, remained engraving residue is reduced, the obtained relief-layer has excellent printing durability, and printing can be carried out for a long period of time without plastic deformation of the relief layer or degradation of printing durability.

In accordance with the present invention, there can be provided a process for producing a flexographic printing plate precursor for laser engraving that has excellent rinsing properties for engraving residue generated at the time of laser engraving and can give a plate having excellent printing durability, a flexographic printing plate precursor obtained by the process, and a flexographic printing plate and a process for making the flexographic printing plate.

### EXAMPLE

The present invention is explained in further detail below by reference to Examples, but the present invention should not be construed as being limited to these Examples. Furthermore, ‘parts’ in the description below means ‘parts by mass’, and ‘%’ means ‘mass %’, unless otherwise specified.

Moreover, the weight-average molecular weight (Mw) and the number-average molecular weight (Mn) of a polymer in the Examples are values measured by a Gel Permeation Chromatography (GPC) method (eluent: tetrahydrofuran) unless otherwise specified.

### Examples 1 to 40 and Comparative Examples 1 to 6

### Examples 1 to 4, 8 to 21, 39, and 40 and Comparative Examples 1 to 5

### 1. Preparation of Resin Composition for Laser Engraving

The N-vinyl compound, polymerizable compound, and binder polymer in the amount described in the following Table 1 or 2, which will be shown later, were put into a three-neck flask equipped with a stirring blade and a cooling tube, and heptane having the same mass as that of the binder polymer was added thereto. The mixed solution was heated for 10 hours at 90° C. under stirring.

Thereafter, the mixed solution was cooled to 70° C., (Component D) a polymerization initiator and (Component E) a photothermal conversion agent in the amount described in Table 1 or 2 were added thereto, and the mixture was stirred for 30 minutes.

By the operation, coating solutions for a crosslinkable relief-forming layer (resin compositions for laser engraving) exhibiting fluidity were obtained respectively.

The blank in Table 1 or 2 indicates that the corresponding component was not added.

### Examples 5 to 7 and 22 to 38

### 1. Preparation of Resin Composition for Laser Engraving

The N-vinyl compound, polymerizable compound, and binder polymer in the amount described in the following Table 1 or 2, which will be shown later, were put into a three-neck flask equipped with a stirring blade and a cooling tube, and cyclohexanone having the same weight as that of the binder polymer was added thereto. The mixed solution was heated for 10 hours at 90° C. under stirring.

Thereafter, in the same manner as in Example 1, coating solutions for a crosslinkable relief-forming layer (resin compositions for laser engraving) were obtained respectively.

### Comparative Example 6

### 1. Preparation of Resin Composition for Laser Engraving

The N-vinyl compound, polymerizable compound, and binder polymer in the amount described in the following Table 2, which will be shown later, were put into a three-neck flask equipped with a stirring blade and a cooling tube, and propylene glycol 1-monomethyl ether 2-acetate (PGMEA) having the same weight as that of the binder polymer was added thereto. The mixed solution was heated for 10 hours at 90° C. under stirring.

Thereafter, in the same manner as in Example 1, a coating solution for a crosslinkable relief-forming layer (resin composition for laser engraving) was obtained.

### 2. Preparation of Flexographic Printing Plate Precursor for Laser Engraving

A spacer (frame) having a predetermined thickness was placed on a PET substrate, the resin composition for laser engraving of each of Examples 1 to 40 and Comparative Examples 1 to 6 was gently cast so that it did not overflow from the spacer (frame), and heated in an oven at 90° C., thus providing a relief-forming layer having a thickness of about 1 mm and producing the corresponding flexographic printing plate precursor for laser engraving. In this process, heating was carried out in the oven at 90° C. until surface tackiness completely disappeared, thus carrying out thermal crosslinking.

### 3. Preparation of Flexographic Printing Plate

A crosslinked relief-forming layer was engraved using the two types of lasers below.

When the resin composition for laser engraving comprised a photothermal conversion agent, a semiconductor laser engraving machine was used. When the resin composition did not comprise a photothermal conversion agent, a carbon dioxide laser engraving machine was used.

As a carbon dioxide laser engraving machine, an ML-9100 series high quality CO₂ laser marker (Keyence Corporation) was used. A flexographic printing plate precursor for laser engraving was subjected to raster-engraving of a 1 cm square solid printed area using the carbon dioxide laser engraving machine under conditions of an output of 12 W, a head speed of 200 mm/sec, and a pitch setting of 2,400 DPI.

As a semiconductor laser engraving machine, laser recording equipment with a fiber-coupled semiconductor laser (FC-LD) SDL-6390 (JDSU, wavelength 915 nm) with a maximum output of 8.0 W was used. A 1 cm square solid printed area was raster-engraved using the semiconductor laser engraving machine under conditions of an output of 7.5 W, a head speed of 409 mm/sec, and a pitch setting of 2,400 DPI.

The thickness of a relief layer of each of the flexographic printing plates of Examples 1 to 40 and Comparative Examples 1 to 6 thus obtained was about 1 mm.

Furthermore, when the Shore A hardness of the relief layer was measured by the above measurement method, it was found to be 75°.

### 4. Evaluation of Flexographic Printing Plates

The performance of a flexographic printing plate was evaluated in terms of items below, and the results are shown in Table 1 or Table 2.

### <Evaluation of Printing Durability>

The obtained relief printing plate was set in a printer (ITM-4 model, manufactured by IYO KIKAI SEISAKUSHO Co., Ltd.). As an ink, a solvent ink (XS-716 507, indigo blue as a primary color (manufactured by DIC GRAPHICS CORPORATION)) was used. Printing was continuously performed using Full Color Form M70 (manufactured by NIPPON PAPER INDUSTRIES CO., LTD., thickness of 100 μm) as printing paper, and highlight of 1 to 10% was checked in the printed matter. A point in time when a halftone dot was not printed was taken as a printing end-point, and length (km) of the paper used to the printing end-point was taken as an index. As the length increases, the printing plate is evaluated to be excellent in printing durability.

### <Evaluation of Rinsing Properties>

A rinsing liquid was prepared by the following method.

A 48% aqueous NaOH solution (manufactured by Wako Pure Chemical Industries, Ltd.) was added dropwise to 500 ml of pure water under stirring so as to regulate pH thereof to be 12.5, thereby preparing a rinsing solution.

To the surface of each of the flexographic printing plates having undergone engraving by the aforementioned method, the prepared rinsing liquid was added dropwise (about 100 ml/m²) by using a dropping pipette such that the surface of plate was evenly wet, and the plate was allowed to standstill for 1 minute. Thereafter, a toothbrush (Clinica Toothbrush Flat manufactured by Lion Corporation) and the plate were rubbed 20 times (30 seconds) against each other under a load of 200 gf, in a state where the toothbrush and the plate were in parallel with each other. Subsequently, the surface of plate was rinsed with running water, water on the surface of plate was then removed, and the plate was naturally dried for about 1 hour.

The surface of plate having undergone rinsing was observed with a microscope (manufactured by KEYENCE CORPORATION) of 100× magnification, and residue remaining on the plate that was not removed by rinsing was evaluated. The evaluation criteria are as follows.

A: No residue remained on the plate

B: A few residues remained in the bottom (concave part) of image.

C: A few residues remained in a convex part of image on the plate, and a few residues remained in the bottom (concave part) of image.

D: A few residues remained in a convex part of image on the plate, and residues remained in the bottom (concave part) of image. However, it is unproblematic for practical use.

E: Residues remained in and adhered to the entire plate.

TABLE 1

| | Formulation | | | | | | | | | | |
|---|---|---|---|---|---|---|---|---|---|---|---|
| | N-vinyl compound | | | Polymerizable compound | | | | | | | |
| | (Component A) | | | (Component B) | | | | | Binder polymer | | |
| | N-vinyl- | N-vinyl- | N-vinyl- | Triallyl | Triallyl | | | | (Component C) | | |
| | caprolactam | pyrrolidone | imidazole | isocyanurate | cyanurate | HDDA | A-DODN | A9300 | BR150L | LBR305 | IR2200L |
| Example 1 | 5 | | | 5 | | | | | 75 | | |
| Example 2 | 5 | | | 5 | | | | | | 75 | |
| Example 3 | 5 | | | 5 | | | | | | | 75 |
| Example 4 | 5 | | | 5 | | | | | | | |
| Example 5 | 5 | | | 5 | | | | | | | |
| Example 6 | 5 | | | 5 | | | | | | | |
| Example 7 | 5 | | | 5 | | | | | | | |
| Example 8 | 9 | | | 1 | | | | | 25 | 50 | |
| Example 9 | 8 | | | 2 | | | | | 25 | 50 | |
| Example 10 | 5 | | | 5 | | | | | 25 | 50 | |
| Example 11 | 3 | | | 7 | | | | | 25 | 50 | |
| Example 12 | 1 | | | 9 | | | | | 25 | 50 | |
| Example 13 | 5 | | | | 5 | | | | 25 | 50 | |
| Example 14 | 5 | | | | | 5 | | | 25 | 50 | |
| Example 15 | 5 | | | | | | 5 | | 25 | 50 | |
| Example 16 | 5 | | | | | | | 5 | 25 | 50 | |
| Example 17 | 5 | | | 5 | | | | | 25 | 55 | |
| Example 18 | 5 | | | 5 | | | | | 25 | 57 | |
| Example 19 | | 5 | | 5 | | | | | 25 | 57 | |
| Example 20 | | | 5 | 5 | | | | | 25 | 50 | |
| Example 21 | 5 | | | 5 | | | | | 25 | 54 | |
| Example 22 | 5 | | | 5 | | | | | 25 | 45 | |
| Example 23 | 5 | | | 5 | | | | | 25 | 40 | |

| | Formulation | | | | | | | | |
|---|---|---|---|---|---|---|---|---|---|
| | Binder polymer | | | | | | | | |
| | (Component C) | | | | | | Evaluation | | Component A/ |
| | | Kraton | Kraton | | PBZ | #45L | Printing | Rinsing | Component B |
| | LIR30 | D-1102 JSZ | D-1161 JP | UV3000B | (Component D) | (Component E) | durability | properties | (molar ratio) |
| Example 1 | | | | | 10 | 5 | 65 | B | 0.60 |
| Example 2 | | | | | 10 | 5 | 40 | B | 0.60 |
| Example 3 | | | | | 10 | 5 | 65 | B | 0.60 |
| Example 4 | 75 | | | | 10 | 5 | 40 | B | 0.60 |
| Example 5 | | 75 | | | 10 | 5 | 65 | C | 0.60 |
| Example 6 | | | 75 | | 10 | 5 | 60 | C | 0.60 |
| Example 7 | | | | 75 | 10 | 5 | 50 | B | 0.60 |
| Example 8 | | | | | 10 | 5 | 25 | B | 5.37 |
| Example 9 | | | | | 10 | 5 | 40 | B | 2.39 |
| Example 10 | | | | | 10 | 5 | 60 | B | 0.60 |
| Example 11 | | | | | 10 | 5 | 50 | B | 0.26 |
| Example 12 | | | | | 10 | 5 | 35 | C | 0.07 |
| Example 13 | | | | | 10 | 5 | 45 | B | 0.60 |
| Example 14 | | | | | 10 | 5 | 30 | C | 0.81 |
| Example 15 | | | | | 10 | 5 | 25 | C | 1.01 |
| Example 16 | | | | | 10 | 5 | 45 | B | 1.01 |
| Example 17 | | | | | 5 | 5 | 45 | B | 0.60 |
| Example 18 | | | | | 3 | 5 | 35 | A | 0.60 |
| Example 19 | | | | | 3 | 5 | 35 | A | 0.75 |
| Example 20 | | | | | 10 | 5 | 35 | B | 0.88 |
| Example 21 | | | | | 10 | 1 | 35 | B | 0.60 |
| Example 22 | | | | | 10 | 10 | 45 | D | 0.60 |
| Example 23 | | | | | 10 | 15 | 40 | D | 0.60 |

TABLE 2

| | Formulation | | | | | | | | |
|---|---|---|---|---|---|---|---|---|---|
| | N-vinyl compound | | | Polymerizable compound | | | | | |
| | (Component A) | | | (Component B) | | | | | |
| | N-vinyl- | N-vinyl- | N-vinyl- | Triallyl | Triallyl | | | | Isobornyl |
| | caprolactam | pyrrolidone | imidazole | isocyanurate | cyanurate | HDDA | A-DODN | A9300 | methacrylate |
| Example 24 | 8 | | | 2 | | | | | |
| Example 25 | 6 | | | 4 | | | | | |
| Example 26 | 3 | | | 7 | | | | | |
| Example 27 | 1 | | | 9 | | | | | |
| Example 28 | 5 | | | | 5 | | | | |
| Example 29 | 5 | | | | | 5 | | | |
| Example 30 | 5 | | | | | | 5 | | |
| Example 31 | 5 | | | | | | | 5 | |
| Example 32 | | 5 | | 5 | | | | | |
| Example 33 | | | 5 | 5 | | | | | |
| Example 34 | 5 | | | 5 | | | | | |
| Example 35 | 5 | | | 5 | | | | | |
| Example 36 | 5 | | | 5 | | | | | |
| Example 37 | 5 | | | 5 | | | | | |
| Example 38 | 5 | | | 5 | | | | | |
| Example 39 | 5 | | | 5 | | | | | |
| Example 40 | 5 | | | 5 | | | | | |
| Example 41 | 5 | | | 5 | | | | | |
| Example 42 | 5 | | | | | | | | 5 |
| Comp. Example 1 | 10 | | | | | | | | |
| Comp. Example 2 | | | | 10 | | | | | |
| Comp. Example 3 | | | | 5 | | 5 | | | |
| Comp. Example 4 | 5 | | | 5 | | | | | |
| Comp. Example 5 | | | | | | 10 | | | |
| Comp. Example 6 | 5 | | | 5 | | | | | |

| | Formulation | | | | | | | | |
|---|---|---|---|---|---|---|---|---|---|
| | Binder polymer | | | | | | | | |
| | (Component C) | | | | | | Polymerization initiator | | |
| | | | Kraton | NISSO-PB | | Adeka | (Component D) | | |
| | BR150L | LBR305 | D-1102 JSZ | GI-3000 | BL7Z | cizer RS540 | PBZ | V60 | Irg 651 |
| Example 24 | | | 75 | | | | 10 | | |
| Example 25 | | | 75 | | | | 10 | | |
| Example 26 | | | 75 | | | | 10 | | |
| Example 27 | | | 75 | | | | 10 | | |
| Example 28 | | | 75 | | | | 10 | | |
| Example 29 | | | 75 | | | | 10 | | |
| Example 30 | | | 75 | | | | 10 | | |
| Example 31 | | | 75 | | | | 5 | | |
| Example 32 | | | 75 | | | | 3 | | |
| Example 33 | | | 75 | | | | 10 | | |
| Example 34 | | | 79 | | | | 10 | | |
| Example 35 | | | 70 | | | | 10 | | |
| Example 36 | | | 65 | | | | 10 | | |
| Example 37 | | | 75 | | | | | | |
| Example 38 | | | 75 | | | | | | |
| Example 39 | | | 75 | | | | | 10 | |
| Example 40 | | | 75 | | | | | | 10 |
| Example 41 | 25 | 55 | | | | | 10 | | |
| Example 42 | 25 | 55 | | | | | 5 | | |
| Comp. Example 1 | 25 | 50 | | | | | 10 | | |
| Comp. Example 2 | 25 | 50 | | | | | 10 | | |
| Comp. Example 3 | 25 | 50 | | | | | 10 | | |
| Comp. Example 4 | | | | | 30 | 35 | 10 | | |
| Comp. Example 5 | 25 | 50 | | | | | 10 | | |
| Comp. Example 6 | | | | 75 | | | 10 | | |

| | Formulation | | | | | |
|---|---|---|---|---|---|---|
| | Photothermal | | | | | |
| | conversion agent | | | | | |
| | (Component E) | | | Evaluation | | Component A/ |
| | | Special | | Printing | Rinsing | Component B |
| | #45L | Black 100 | MA100 | durability | properties | (molar ratio) |
| Example 24 | 5 | | | 60 | C | 2.39 |
| Example 25 | 5 | | | 70 | C | 0.90 |
| Example 26 | 5 | | | 60 | C | 0.26 |
| Example 27 | 5 | | | 45 | D | 0.07 |
| Example 28 | 5 | | | 55 | C | 0.60 |
| Example 29 | 5 | | | 40 | D | 0.81 |
| Example 30 | 5 | | | 35 | D | 1.01 |
| Example 31 | 5 | | | 55 | C | 1.01 |
| Example 32 | 5 | | | 45 | B | 0.75 |
| Example 33 | 5 | | | 45 | C | 0.88 |
| Example 34 | 1 | | | 45 | C | 0.60 |
| Example 35 | 10 | | | 55 | D | 0.60 |
| Example 36 | 15 | | | 45 | D | 0.60 |
| Example 37 | | 5 | | 75 | D | 0.60 |
| Example 38 | | | 5 | 50 | B | 0.60 |
| Example 39 | 5 | | | 40 | C | 0.60 |
| Example 40 | 5 | | | 30 | C | 0.60 |
| Example 41 | | | | 25 | B | 0.60 |
| Example 42 | 5 | | | 25 | D | 1.60 |
| Comp. Example 1 | 5 | | | 15 | B | — |
| Comp. Example 2 | 5 | | | 15 | D | — |
| Comp. Example 3 | 5 | | | 20 | D | — |
| Comp. Example 4 | 5 | | | 15 | B | 0.60 |
| Comp. Example 5 | 5 | | | 35 | E | — |
| Comp. Example 6 | 5 | | | 10 | C | 0.60 |

The unit of numerical values in the column of formulation in Tables 1 and 2 is “part(s) by mass”.

Moreover, the details of the respective component in Tables 1 and 2 are as follows, and a weight average molecular weight Mw of each binder polymer is shown in Table 3.

BR150L: polybutadiene, UBEPOL BR 150L manufactured by UBE INDUESTRIES, LTD.

LBR305: polybutadiene, LBR-305 manufactured by KURARAY CO., LTD.

IR2200L: polyisoprene, Nipol IR2200L manufactured by ZEON Corporation, Japan.

LIR30: polyisoprene, LIR-30 manufactured by KURARAY CO., LTD.

Kraton D-1102 JSZ: styrene-butadiene-styrene block copolymer (SBS resin), manufactured by Kraton Performance Polymers Inc.

Kraton D-1161 JP: styrene-isoprene-styrene block copolymer (SIS resin), manufactured by Kraton Performance Polymers Inc.

UV3000B: urethane acrylate oligomer (having a (meth)acryloyl group on the terminal of main chain), SHIKOH UV-3000B manufactured by Nippon Synthetic Chemical Industry Co., Ltd.

NISSO-PB GI-3000: hydrogenated polybutadiene having an OH group on both terminals, manufactured by NIPPON SODA CO., LTD.

BL7Z: polyvinyl butyral, BL-7Z manufactured by SEKISUI CHEMICAL CO., LTD.

ADEKA CIZER RS-540: polyether ester-based plasticizer, manufactured by ADEKA CORPORATION

TABLE 3

| Binder polymer | Mw |
|---|---|
| BR150L | 470,000 |
| LBR305 | 28,000 |
| IR2200L | 1,350,000 |
| LIR30 | 33,000 |
| Kraton D-1102 JSZ | 100,000 |
| Kraton D-1161 JP | 100,000 |
| UV3000B | 30,000 |
| NISSO-PB GI-3000 | 5,800 |
| BL7Z | 30,000 |

N-vinylcaprolactam: N-vinyl-ε-caprolactam (NVC), manufactured by Tokyo Chemical Industry Co., Ltd., melting point: 35 to 38° C.

N-vinylpyrrolidone: N-vinyl-2-pyrrolidone (NVP), manufactured by Tokyo Chemical Industry Co., Ltd., melting point: 13° C.

N-vinylimidazole: manufactured by Tokyo Chemical Industry Co., Ltd., melting point: 78° C.

Triallyl isocyanurate: manufactured by Tokyo Chemical Industry Co., Ltd., melting point: 24° C.

Triallyl cyanurate: manufactured by Tokyo Chemical Industry Co., Ltd., melting point: 26° C.

HDDA: 1,6-hexanediol diacrylate, NK Ester A-HD-N manufactured by SHIN-NAKAMURA CHEMICAL CO., LTD., melting point: 8° C.

A-DODN: 1,10-decanediol diacrylate, NK Ester A-DOD-N manufactured by SHIN-NAKAMURA CHEMICAL CO., LTD., melting point: unknown (staying liquid at 0° C.)

A9300: tris(2-acryloxyethyl)isocyanurate, NK Ester A-9300 manufactured by SHIN-NAKAMURA CHEMICAL CO., LTD., melting point: 50° C.

Isobornyl methacrylate: manufactured by Tokyo Chemical Industry Co., Ltd., melting point: −60° C.

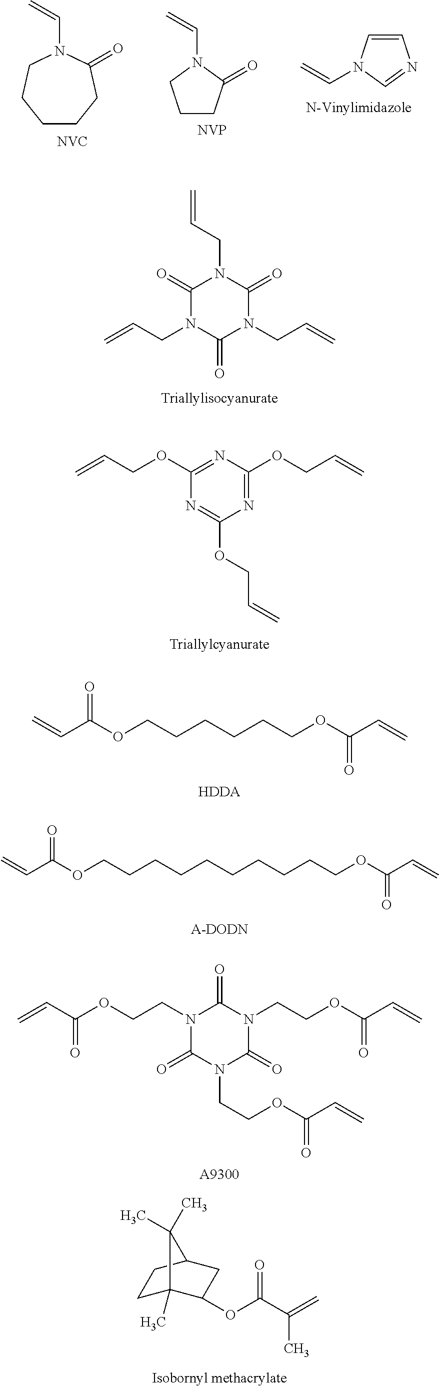

PBZ: polymerization initiator, t-butylperoxybenzoate, Perbutyl Z manufactured by NOF CORPORATION

V60: polymerization initiator, 2,2′-azobisisobutyronitrile (AIBN), V-60 manufactured by Wako Pure Chemical Industries, Ltd.

Irg 651: polymerization initiator, 2,2-dimethoxy-1,2-diphenylethan-1-one, IRGACURE 651 manufactured by BASF Japan, Ltd.

#45L: photothermal conversion agent, carbon black, average primary particle diameter: 24 nm, BET specific surface area: 125 m²/g, DBP oil absorption number: 45 cm³/100 g, manufactured by Mitsubishi Chemical Corporation

Special Black 100: photothermal conversion agent, carbon black, average primary particle diameter: 50 nm, BET specific surface area: 30 m²/g, DBP oil absorption number: 94 cm³/100 g, manufactured by Degussa Corporation

MA100: photothermal conversion agent, carbon black, average primary particle diameter: 24 nm, BET specific surface area: 110 m²/g, DBP oil absorption number: 100 cm³/100 g, manufactured by Mitsubishi Chemical Corporation

What is claimed is:

1. A process for producing a flexographic printing plate precursor for laser engraving, comprising steps of:
forming a relief-forming layer formed of a resin composition for laser engraving; and
crosslinking the relief-forming layer by means of heat and/or light to thus obtain a flexographic printing plate precursor having a crosslinked relief-forming layer,
wherein the resin composition for laser engraving comprises (Component A) an N-vinyl compound, (Component B) a polymerizable compound, (Component C) an ethylenically unsaturated bond-containing binder polymer, and (Component D) a polymerization initiator.

2. The process for producing a flexographic printing plate precursor for laser engraving according to claim 1, wherein Component A is N-vinyllactams.

3. The process for producing a flexographic printing plate precursor for laser engraving according to claim 1, wherein Component A is a compound represented by the following Formula (A-1), 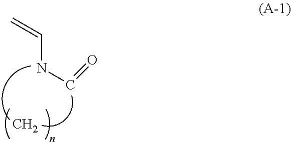
wherein, in Formula (A-1), n represents an integer of 2 to 6.

4. The process for producing a flexographic printing plate precursor for laser engraving according to claim 1, wherein Component A is N-vinyl-ε-caprolactam.

5. The process for producing a flexographic printing plate precursor for laser engraving according to claim 1, wherein, in the resin composition, a molar ratio between a total amount of the ethylenically unsaturated group of Component A and a total amount of the ethylenically unsaturated group of Component B (value of Component A/value of Component B) is at least 0.05 but no greater than 3.

6. The process for producing a flexographic printing plate precursor for laser engraving according to claim 1, wherein Component B is a compound having an isocyanuric acid structure or a cyanuric acid structure.

7. The process for producing a flexographic printing plate precursor for laser engraving according to claim 1, wherein Component B is a compound having an allyl group.

8. The process for producing a flexographic printing plate precursor for laser engraving according to claim 1, wherein a content of Component A is less than 20 mass % relative to a total mass of the resin composition.

9. The process for producing a flexographic printing plate precursor for laser engraving according to claim 1, wherein Component C comprises a resin having a monomer unit derived from butadiene and/or a monomer unit derived from isoprene.

10. The process for producing a flexographic printing plate precursor for laser engraving according to claim 1, wherein the resin composition for laser engraving further comprises (Component E) a photothermal conversion agent.

11. The process for producing a flexographic printing plate precursor for laser engraving according to claim 10, wherein Component E is carbon black.

12. The process for producing a flexographic printing plate precursor for laser engraving according to claim 11, wherein an average primary particle diameter of the carbon black is greater than 20 nm but less than 80 nm.

13. The process for producing a flexographic printing plate precursor for laser engraving according to claim 11, wherein a DBP oil absorption number of the carbon black is 40 to 150 mL/100 g.

14. The process for producing a flexographic printing plate precursor for laser engraving according to claim 10, wherein a content of Component E is 1 to 20 mass % relative to a total mass of the resin composition.

15. The process for producing a flexographic printing plate precursor for laser engraving according to claim 1, wherein a content of Component C is 50 to 85 mass % relative to a total mass of the resin composition.

16. The process for producing a flexographic printing plate precursor for laser engraving according to claim 1, wherein the crosslinking step is a step of crosslinking the relief-forming layer by means of heat to thus obtain a flexographic printing plate precursor having a crosslinked relief-forming layer.

17. A flexographic printing plate precursor for laser engraving obtained by the production process according to claim 1.

18. A process for making a flexographic printing plate, comprising steps of:
an engraving step of laser-engraving the flexographic printing plate precursor for laser engraving obtained by the production process according to claim 1 to thus form a relief layer; and
a rinsing step of rinsing the surface of the relief layer with a rinsing liquid.

19. The process for making a flexographic printing plate according to claim 18, wherein the rinsing liquid is an alkaline rinsing liquid having a pH of 8 to 14.

20. A flexographic printing plate obtained by the process for making a flexographic printing plate according to claim 18.
